(19) United States
(12) Patent Application Publication
(10) Pub. No.: US 2026/0147852 A1
(43) Pub. Date: May 28, 2026

(54) SPARSE COMPUTE-IN-MEMORY TENSOR CORE

(71) Applicant: MOFFETT INTERNATIONAL CO., LIMITED, Kowloon (HK)

(72) Inventors: Changxu ZHANG, Santa Clara, CA (US); Xiaoqian ZHANG, San Jose, CA (US)

(21) Appl. No.: 18/957,512

(22) Filed: Nov. 22, 2024

(51) Int. Cl. G06F 17/16; G06F 7/501; G06F 7/76

(52) U.S. Cl. CPC G06F 17/16; G06F 7/501; G06F 7/762

(57) ABSTRACT

A compute-in-memory (CIM) tensor core includes a memory, a control circuit, and a plurality of processing units (PUs) organized in a 2-dimensional (2D) mesh network. Each PU includes a first circuit configured for low-precision (LP) compute-in-memory (CIM) operations. Additionally, a subset of PUs within a central region of the 2D mesh network further includes a second circuit configured for high-precision (HP) CIM operations, in addition to the LP circuit. This architecture enables integrated storage and computation within the same hardware units, reducing data movement and improving processing efficiency.

### TECHNICAL FIELD

The present invention relates to the field of computer processors and machine learning, specifically to a compute-in-memory (CIM) tensor core designed for efficient and flexible processing of sparse tensor computations.

### BACKGROUND

The growing computational demands of tensor multiplication in artificial intelligence (AI) accelerators have led to a substantial increase in the number of parallel computing units. As tensor multiplication is central to neural network models, particularly in deep learning, it requires a multi-stage computational pipeline that involves extensive data transfer between stages. The volume of data movement across various stages in the pipeline has introduced challenges, particularly with respect to hardware interconnections. As data passes from one computation stage to the next, a significant number of connections must be maintained, adding complexity to the hardware design and creating bottlenecks. These data transfers not only increase the system's power consumption but also introduce latency, both of which are further exacerbated as computing power continues to grow.

A common method to reduce computational cost and memory footprint in neural network processing is tensor sparsification, which selectively reduces the number of non-zero elements in tensors. This sparsification reduces the volume of data and operations required, ultimately conserving both memory and processing resources. However, sparse tensors, in contrast to dense tensors, require a distinct computational pattern, posing further design challenges. Implementing separate circuits tailored to sparse and dense tensors is costly and increases the physical size of the chip, limiting scalability and efficiency.

A promising approach to address these issues is to integrate computation and storage within the same hardware unit, enabling a versatile platform that can efficiently handle both sparse and dense tensor computations. By positioning processing units closer to memory or even integrating memory directly within computational units, data transfers between modules can be minimized, reducing the need for extensive interconnect wiring and shortening data paths. This not only simplifies the hardware design but also improves efficiency. With storage elements located near or within computational units, data can be fetched and processed more rapidly, reducing latency and improving throughput.

### SUMMARY

Various embodiments of the present specification may include a tensor core with a compute-in-memory (CIM) architecture to support efficient and flexible processing of sparse tensor computations. A system composed of one or more computers can be configured to perform specific operations or actions by installing software, firmware, hardware, or a combination of these elements. This configuration enables the system to carry out the designated actions. Similarly, computer programs can be designed to perform particular operations by including instructions that, when executed by data processing apparatus, prompt the apparatus to execute these actions.

In one general aspect, a tensor core may include a memory, a control circuit, and a plurality of processing units (PUs) organized in a 2-dimensional (2D) mesh network, where each of the plurality of PUs has a first circuit configured for low-precision (LP) computation, and in a subset of the plurality of PUs located within a central region of the 2D mesh network, each of the subset of PUs further may include, in addition to the first circuit, a second circuit configured for high-precision (HP) computation. Other embodiments of this aspect include corresponding computer systems, apparatus, and computer programs recorded on one or more computer storage devices, each configured to perform the actions of the methods.

Implementations may include one or more of the following features. A tensor core where the first circuit is configured to support compute-in-memory computation, and the first circuit may include at least one activation register, at least one weight register, an LP vector multiplier, an LP vector adder, a scalar adder, and an accumulation register. A tensor core where the second circuit is configured to support compute-in-memory computation, and the second circuit may include at least one activation register, at least one weight register, an HP vector multiplier, and an HP vector adder.

The plurality of PUs are configured to receive a sparse tensor for computation, where the sparse tensor is represented by a condensed tensor using HP bits to represent high-magnitude tensor data of the sparse tensor, and a bitmask using LP bits to represent all tensor data of the sparse tensor. A tensor core where the control circuit is configured to send control instructions to distribute the condensed tensor to the second circuits of the subset of PUs in the central region of the 2D mesh network for HP computation, and to distribute the LP bits to the first circuits of the plurality of PUs in the 2D mesh network for LP computation.

The control circuit configures the plurality of PUs as a gather circuit, in which the plurality of PUs are configured to receive tensor data, and the subset of the PUs in the center region of the 2D mesh network is configured to gather and output high-magnitude tensor data in the received data. A tensor core where the control circuit configures the plurality of PUs as a scatter circuit, in which the subset of the PUs in the center region of the 2D mesh network is configured to receive high-magnitude tensor data, and the plurality of PUs is configured to scatter the high-magnitude tensor data to a dense tensor and output the dense tensor.

A tensor core may include a center adder circuit located in the center of the 2D mesh network, connected to a quartet of innermost PUs in the 2D mesh network, where the center adder circuit may include an HP scaling register that stores an HP scaling parameter, an LP scaling register that stores an LP scaling parameter, an HP vector multiplier coupled to the HP scaling register, an LP vector multiplier coupled to the LP scaling register, and a vector adder coupled to the HP vector multiplier and the LP vector multiplier.

A tensor core where the HP vector multiplier is configured to receive a result of the HP computation from the second circuits of the subset of PUs in the central region of the 2D mesh network, generate a scaled result of the HP computation by applying the HP scaling parameter from the HP scaling register, and transmit the scaled result of the HP computation to the vector adder for accumulation with a scaled result of the LP computation. A tensor core where the LP vector multiplier is configured to receive a result of the LP computation from the first circuits of the plurality of PUs in the 2D mesh network, generate a scaled result of the LP computation by applying the LP scaling parameter from the LP scaling register, and transmit the scaled result of the LP computation to the vector adder for accumulation with a scaled result of the HP computation.

A tensor core where the center adder circuit may include bi-directional connections with two non-adjacent PUs of the quartet of innermost PUs in the 2D mesh network, and uni-directional connections with the other two non-adjacent PUs of the quartet of innermost PUs in the 2D mesh network. A tensor core where the center adder circuit is configured to generate a vector result based on a result of the HP computation and a result of the LP computation, and redistribute the vector result back to the plurality of PUs for accumulation in the next round of computation.

A tensor core where the control circuit configures the first circuits of the plurality of PUs as an LP mesh adder tree, LP tensor data are accumulated through the LP mesh adder tree and flow towards a root node of the LP mesh adder tree, and the root node corresponds to one of the quartet of innermost PUs. A tensor core where the control circuit configures the second circuits of the subset of PUs in the central region of the 2D mesh network as an HP mesh adder tree, HP tensor data are accumulated through the HP mesh adder tree and flow towards a root node of the HP mesh adder tree, and the root node corresponds to one of the quartet of innermost PUs.

A tensor core where the plurality of PUs is configurable to perform either intra-PU accumulation or cross-PU accumulation. A tensor core where the control circuit configures the plurality of PUs to perform either intra-PU accumulation or cross-PU accumulation, depending on whether an input tensor for computation is distributed by input channel or by output channel. Implementations of the described techniques may include hardware, a method or process, or a computer tangible medium.

In one general aspect, a method may include receiving a sparse tensor for computation, where the sparse tensor is represented by (1) a condensed tensor using high-precision (HP) bits to represent high-magnitude tensor data of the sparse tensor, and (2) low-precision (LP) bits representing all tensor data of the sparse tensor. The method may also include distributing the sparse tensor to a plurality of processing units (PUs), where the plurality of PUs is organized in a 2-dimensional (2D) mesh network, each of the plurality of PUs may include a first circuit configured for LP computation, and in a subset of the plurality of PUs located in a central region of the 2D mesh network, each of the subset of PUs may further include, in addition to the first circuit, a second circuit configured for HP computation.

The method may furthermore include obtaining a result of the LP computation from the first circuits of the plurality of PUs and a result of the HP computation from the second circuits of the subset of PUs in the central region of the 2D mesh network. The method may in addition include generating an output tensor based on the result of the LP computation and the result of the HP computation. Other embodiments of this aspect include corresponding computer systems, apparatus, and computer programs recorded on one or more computer storage devices, each configured to perform the actions of the methods.

Implementations may include one or more of the following features. A method for distributing the sparse tensor to the plurality of PUs may include distributing the condensed tensor to the second circuits of the subset of PUs in the central region of the 2D mesh network for the HP computation, and distributing the LP bits to the first circuits of the plurality of PUs in the 2D mesh network for LP computation.

A method where the 2D mesh network may further include a center adder circuit located in the center of the 2D mesh network, connected to the quartet of innermost PUs in the 2D mesh network, where the center adder circuit may include an HP scaling register that stores an HP scaling parameter, an LP scaling register that stores an LP scaling parameter, an HP vector multiplier coupled to the HP scaling register, an LP vector multiplier coupled to the LP scaling register, and a vector adder coupled to the HP vector multiplier and the LP vector multiplier.

A method where generating the output tensor based on the result of the LP computation and the result of the HP computation may include feeding the result of the LP computation and the result of the HP computation to the center adder circuit, generating a scaled result of the LP computation using the LP vector multiplier by applying the LP scaling parameter from the LP scaling register, generating a scaled result of the HP computation using the HP vector multiplier by applying the HP scaling parameter from the HP scaling register, and accumulating the scaled result of the LP computation and the scaled result of the HP computation using the vector adder to obtain the output tensor. Implementations of the described techniques may include hardware, a method or process, or a computer tangible medium.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates a pipeline-based tensor core for sparse tensor computation in neural networks, in accordance with various embodiments.

FIG. 2 illustrates an exemplary compute-in-memory (CIM) tensor core for sparse tensor computation in neural networks, in accordance with various embodiments.

FIG. 3 illustrates an exemplary architecture diagram of the CIM tensor core, in accordance with various embodiments.

FIG. 4A illustrates an original butterfly network configured as a gather circuit for sparse encoding.

FIG. 4B illustrates an original butterfly network configured as a scatter circuit for sparse encoding.

FIG. 4C illustrates an exemplary configuration of the CIM tensor core as 2D flattened butterfly network to function as a gather circuit or a scatter circuit, in accordance with various embodiments.

FIG. 5 illustrates an exemplary configuration of the CIM tensor core as a multi-layer mesh adder tree for performing both low-precision (LP) and high-precision (HP) tensor computations, in accordance with various embodiments.

FIG. 6 illustrates an exemplary configuration of the CIM tensor core as a distribute network, in accordance with various embodiments.

FIG. 7 illustrate two computation modes supported by the CIM tensor core, in accordance with various embodiments.

FIG. 8 illustrate an example method performed by the CIM tensor core, in accordance with various embodiments.

### DETAIL DESCRIPTION OF THE EMBODIMENTS

Embodiments described herein provide methods, systems, apparatus for efficient and flexible processing of sparse tensor computations using a tensor core with a compute-in-memory (CIM) architecture.

A neural network computation involves the interaction between activation tensors and weight tensors to process and transform data through the network's layers. Activation tensors represent the input data or the outputs from preceding layers, encapsulating multi-dimensional arrays of numerical values that carry essential information for tasks such as classification or prediction. Weight tensors contain the network's learnable parameters, determining the strength and direction of connections between neurons. During computation, the weight tensor is applied to the activation tensor through operations like matrix multiplication or convolution, effectively aggregating and transforming the input data based on the learned weights. This process is typically followed by adding a bias tensor and applying an activation function, which introduces non-linearity and enables the network to model complex patterns. The continuous interplay between activation and weight tensors allows the neural network to learn from data, adjust its parameters during training, and make accurate predictions during inference.

As mentioned in the background section, sparsification in neural networks involves reducing the number of elements in weight tensors or activation tensors, thereby lowering the computational burden and memory requirements. The sparsity of neural networks can be achieved through methods such as pruning, quantization, and regularization. For example, sparsification eliminates low-magnitude elements while retaining high-magnitude elements. These methods reduce the density of neural network tensors, leading to more efficient model execution.

The sparsity of neural networks can be achieved through techniques such as pruning, quantization, and regularization. These approaches reduce the density of neural network tensors, enabling more efficient model execution. However, they also inevitably lead to a loss of precision in the tensor data. Ideally, a neural network computation circuit should harness the benefits of sparsification while being able to provide precision compensation to mitigate the precision loss caused by these techniques.

This disclosure uses distinct types of tensors to help describe the invention, such as dense tensors, sparse tensors, condensed tensors, and sparse uncondensed tensors.

A dense tensor refers to a tensor in its original size, characterized by the number of elements and the bit-depth (precision) of these elements as received from upstream or downstream processing engines. The dense tensor may include high-magnitude data and low-magnitude data. When a dense tensor contains a large number of zero-valued data, it is called a sparse tensor.

The sparse tensor may be represented and stored in different data formats using a combination of a condensed tensor, a bitmask, and optional quantization information. A condensed tensor represents a compressed version of a given tensor, the bitmask maps the data in the condensed tensor with the original tensor, and the quantization information includes quantization parameters used when generating the condensed tensor from the original tensor.

In a narrow-sense sparse representation, the sparse representation of a sparse tensor may include a condensed tensor and a bitmask. The condensed tensor only stores non-zero elements from a sparse tensor, and the bitmask uses binary values to indicate the original positions of the non-zero elements in the given tensor. The condensed tensor in combination of the bitmask can be used to restore the given tensor. The restoration may be necessary for certain tensor operations (e.g., max or average pooling) or hardware processing units.

In a more general-sense sparse representation, the sparse representation of a sparse tensor may include a condensed tensor and a bitmask. The condensed tensor stores high-magnitude elements in the original tensor (e.g., a dense tensor). The bitmask uses multi-bits values to indicate not only the original positions of the high-magnitude elements in the original tensor, but also encoded value information of the low-magnitude elements in the original tensor. The “high-magnitude elements” refer to elements that exceed a value threshold, indicating significance of these elements for the tensor computation. The condensed tensor in combination of the multi-bit bitmask can be used to restore the given tensor.

In some embodiments, if quantization is performed when converting the given tensor into the corresponding condensed tensor, the quantization parameters (e.g., scale and bias) may be stored as part of the sparse representation in addition to the condensed tensor and the bitmask. While quantization reduces the data precision, the quantization parameters may be used to reverse (to some extent) the data precision when converting the condensed tensor back to its dense format.

The sparse uncondensed tensor is an expanded version of the condensed tensor. Elements from the condensed tensor are scattered and distributed into this larger tensor, which contains more positions or “spots” than the condensed tensor. Since the elements from the condensed tensor occupy only a subset of these spots, the remaining positions are filled with zero-valued elements, rendering the uncondensed tensor sparse.

In some scenarios, the dense tensor and the sparse uncondensed tensor share the same size and dimensions, while the condensed tensor has a smaller size. The bit-depth of the dense tensor is higher than that of the condensed tensor. The bit-depth of the sparse uncondensed tensor may remain the same as that of the dense tensor.

In neural networks sparsification, sparse encoding is a process to convert a dense tensor (either a weight tensor or an activation tensor) into a sparse representation. The sparse representation of the dense tensor may include a condensed tensor, a low-bit bitmask, and optional quantization parameters. This condensed tensor captures only the non-zero elements, significantly reducing the amount of data that needs to be processed or transmitted. The low-bit bitmask uses low bit-depth to represent the low magnitude elements. The optional quantization parameters include the parameters used during the quantization (if any) of the dense tensor, and will be used to restore the sparse representation back to the dense format (i.e., as a result of the sparse decoding). Sparse encoding is particularly beneficial for improving computational efficiency and reducing memory usage in scenarios where the majority of the tensor elements are zeros. The circuit implementing sparse encoding is often referred to as a gather network.

However, the sparsification process introduces new challenges that must be addressed to fully exploit the benefits of sparse computing. Not all neural network operations or upstream hardware/accelerators are designed to handle sparse data natively. Many standard operations, such as max pooling and average pooling, as well as interactions with dense layers, require tensors in their original dense format. To address this need, sparse decoding is required. Sparse decoding is the reverse of sparse encoding. It reconstructs the dense tensor from its sparse representation by reintroducing the low-magnitude elements (e.g., zeros) at their appropriate positions. The circuit implementing sparse decoding is often referred to as a scatter network.

Inventor has several pipeline-based tensor core architectures, including single or dual sparse processing units (e.g., “single” means only one of the two input tensors is sparse, “dual” means both input tensors are sparse). In these architectures, tensor computations are divided into multiple stages. These stages typically include loading input tensors into cache, performing sparse encoding in preparation for computation, performing tensor multiplication through a multiplier, performing accumulation using an adder tree, scaling the accumulation results by applying corresponding scaling factors, accumulating the result with previously cached partial results, and performing sparse decoding. Some of these stages are optional depending on the implementation, and the stages may not be executed in the above-mentioned order.

While the pipeline-based tensor core architecture provides functional separation of computational stages, it also presents limitations, especially as processing requirements increase. For instance, supporting more computation-intensive tasks requires enlarging the hardware footprint to accommodate increased wiring between components, such as between the multiplier and adder tree. This increase in physical size not only diminishes scalability for high-performance workloads but also leads to inefficiencies, including unnecessary hardware resource utilization, increased heat generation, and higher cooling requirements.

To address these challenges, this disclosure presents a CIM-based tensor core architecture that integrates computation with data storage to optimize the efficiency of tensor multiplication processes. The CIM architecture is designed to accommodate different modes of sparse tensor computations using the same hardware components. By reconfiguring the same circuits to perform multiple functionalities across various stages of tensor computation, the CIM architecture avoids the need for separate circuits, reducing chip size and cost. This streamlined and flexible design supports efficient processing for both sparse and dense tensors, making it highly suitable for scalable, high-performance AI applications.

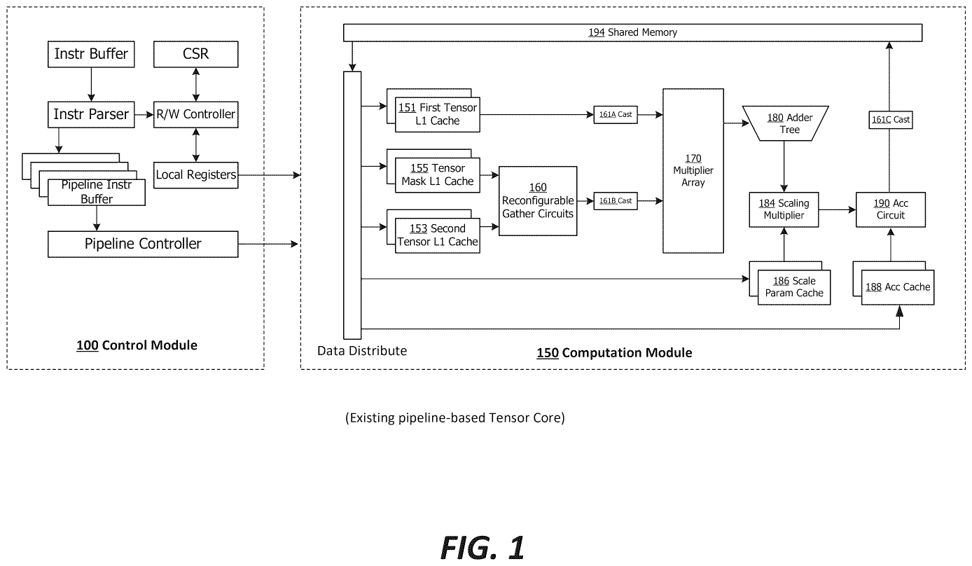

FIG. 1 illustrates a pipeline-based tensor core for sparse tensor computation in neural networks, in accordance with various embodiments. The example tensor core in FIG. 1 is a single-axis sparse tensor processing circuit that includes a control circuit 100 and a computation module 150.

The control circuit 100 receives neural network computation instructions from high level in the system, such as a host device, and dispatches the instructions to the components in the computation module to carry out the neural network computation.

The control circuit 100 includes various components designed to manage and direct neural network computations. These components may include an instruction queue configured to receive computation instructions, such as memory addresses for input tensors, the type of computation to be performed, and the destination memory address for storing the output tensor. The control circuit 100 also comprises local (engine) registers, which serve as the interface for configuring and instructing the computation module 150. The control circuit 100 may further include an instruction parser for interpreting the instructions within the instruction queue. Additionally, the control circuit 100 includes a register read/write controller that is used to get necessary data flow read/write control information from control/status registers (CSR) or instructions, a pipeline instruction buffer that acts as a staging area for buffering instructions, local registers that materialize the configurations specified by the engine registers, and pipeline controller responsible for executing the instructions fetched from the pipeline instruction buffer.

The computation module 150 implements a pipeline for executing the neural network computations. As shown, the computation module 150 may include a data distribute interface accepting input data as well as other parameters from the control circuit 100, a first tensor L1 cache 151, a second tensor L1 cache 153, a tensor mask L1 Cache 155, a group of reconfigurable gather circuits 160, a plurality of cast circuits 161A-161C (denoted as Cast 161A, Cast 161B and Cast 161C in FIG. 1), a multiplier array 170, an adder tree module 180, a scaling multiplier module 184, a scale parameter cache 186, an accumulation circuit 190 (denoted as ACC Circuit 190 in FIG. 1), an accumulate cache 188 (denoted as ACC Cache 188 in FIG. 1), and a shared memory 194.

A basic neural network computation involves two tensors, such as an activation tensor and a weight tensor. The first tensor L1 cache 151 and the second tensor L1 cache 153 are configured to cache the input tensors, including a first tensor (e.g., the activation tensor) and a second tensor (e.g., the weight tensor). The tensor mask L1 cache 155 is configured to cache a tensor mask corresponding to the second tensor. In some embodiments, the tensor mask is a bitmask from the shared memory that may have been generated by the computation module 150. This tensor mask identifies non-zero tensor data (e.g., non-zero data or data exceeding a specific threshold) within the second tensor, thereby facilitating the sparsification of the second tensor by eliminating zero-valued data.

The reconfigurable gather circuits 160 is configured to receive data from the second tensor L1 cache 153 and the tensor mask L1 cache 155, and execute the sparsification of the second tensor based on the tensor mask. The sparsification transforms the second tensor from a dense format into a condensed format based on the tensor mask. In some embodiments, the condensed format of the second tensor includes a condensed tensor that only contains the non-zero elements (in some cases, these elements are also quantized to reduce the bit-depth to reduce memory footprint and computational cost), a low-bit bitmask indicating the zero-valued elements that are pruned out, and optional quantization parameters when the sparsification involves quantizing the tensor data. In some cases, the sparsification performed by the reconfigurable gather circuits 160 may be based on one axis (e.g., single-axis sparsification) of the second tensor, such as the input channel of the weight tensor, the input channel of the activation tensor, or the output channel of the activation tensor.

Sparsification of the second tensor may alter its data type, for example, converting it from a high-precision format (e.g., 32-bit in the dense format) to a low-precision format (e.g., 8-bit in the condensed format), while the first tensor in the first tensor L1 cache 151 remains in its original format (e.g., either a dense format or a condensed format from anther engine). To continue tensor operations, these two tensors are passed through cast circuits for data type conversion, ensuring they are converted to the same data type. The output from the cast circuits is then fed into the multiplier array 170 to proceed with the computation. As illustrated in FIG. 1, a first cast circuit 161A is connected to the first tensor L1 cache 151 for casting the first tensor, and a second cast circuit 161B is connected to the reconfigurable gather circuits 160 to cast the condensed format of the second tensor.

The multiplier array 170 performs the tensor computation based on the first tensor and the condensed format of the second tensor, and generate an intermediate tensor. The intermedia tensor may be fed into the adder tree 180 for accumulation, thereby completing one cycle of MAC (Multiplication-and-Accumulation) operations on the input tensors.

Subsequently, the output of the adder tree 180 may go through the scaling multiplier 184 based on a scale parameter stored in the scale param cache 186. The scaling process on the tensor may include adjusting the magnitude or range of tensor values before the subsequent accumulation with another intermediate tensor. This scaling process may be needed to support mixed-precision techniques, where different parts of the computation in the sparse tensor processing circuit use varying levels of numerical precision to balance performance and accuracy.

The accumulation circuit 190 may be configured to perform summation on the intermediate tensor output from the scaling multiplier 184 and another tensor read from the accumulate cache 188 (e.g., another intermedia tensor from a previous computation cycle). In some cases, the output of the accumulation circuit 190 may be stored in the accumulate cache 188 for the next round of computation. In other cases, the output of the accumulation circuit 190 may go through another cast circuit 161C before being stored into the shared memory 194 as the output tensor of the neural network computation.

As shown in FIG. 1, the sparse tensor computation is divided into discrete stages, with each stage executed by dedicated hardware units. Intermediate data is transmitted from one hardware unit to the next via wired connections. While this design is straightforward and suitable for applications where performance demands are moderate, it poses challenges in high-performance scenarios. In those cases, additional wiring between hardware units may be required to achieve higher throughput, which increases both the cost and complexity of the chip design (e.g., necessitating more intricate wiring schemes).

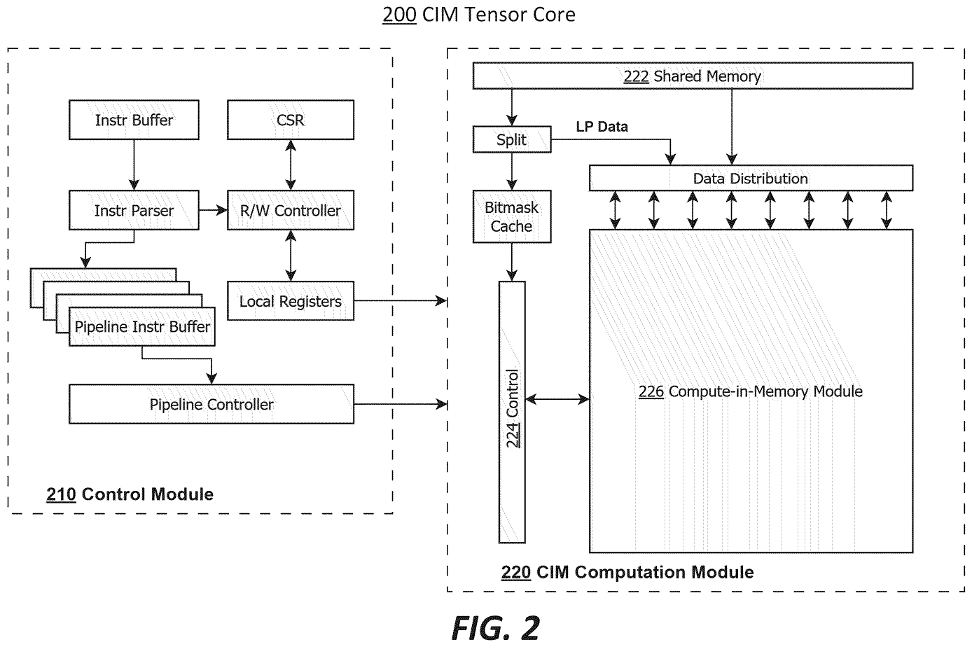

FIG. 2 illustrates an exemplary compute-in-memory (CIM) tensor core designed for sparse tensor computation in neural networks, in accordance with various embodiments. The CIM tensor core 200 includes a control module 210, which functions similarly to the control module 100 in the pipeline-based tensor core shown in FIG. 1. Additionally, the CIM tensor core 200 incorporates a CIM computation module 220 configured to execute tensor computations. This CIM computation module 220 includes a shared memory 222 for storing input and/or output tensors, a control circuit 224 for configuring tensor computations, and a configurable CIM Processing Unit (PU) array 226 that executes multiple stages of tensor computation using the same array of PUs. In some embodiments, a first tensor read from shared memory 222 is distributed through the data distribution circuit to the processing units within CIM module 226. Concurrently, a second tensor—such as a sparse tensor intended for computation with the first tensor—also read from shared memory 222, first passes through a split circuit that separates the low-precision data. This low-precision data is then distributed via the data distribution circuit to the processing units in CIM module 226. Additionally, the split circuit generates a bitmask that is stored in a bitmask cache and subsequently provided to control circuit 224. The control circuit uses this bitmask to configure the data distribution and computations performed within the CIM module.

A key distinction between the CIM tensor core 200 and the pipeline-based tensor core in FIG. 1 is the absence of a sequential pipeline structure within the configurable CIM PU array 226. Unlike traditional designs that rely on a series of separate storage and computation components, the CIM architecture allows intermediate computation results to remain within the same hardware structure, eliminating the need for whole-scale data migration from one component to another. This not only reduces data transfer time and cost but also enhances overall performance.

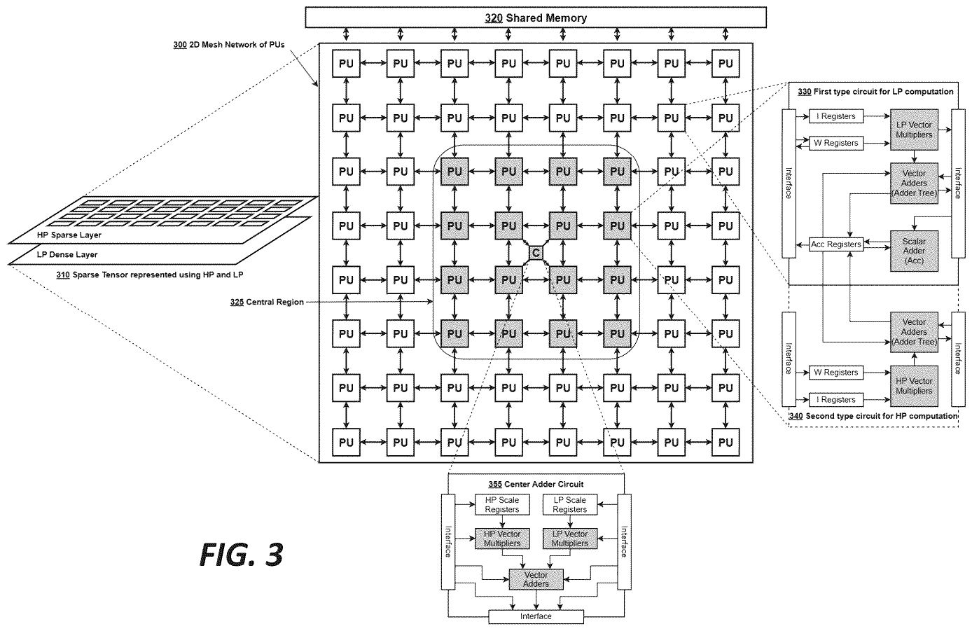

FIG. 3 illustrates an exemplary architecture diagram of the CIM tensor core, in accordance with various embodiments. In particular, the diagram of the CIM tensor core in FIG. 3 illustrates an example of the configurable CIM PU array 226 from FIG. 2.

In some embodiments, the CIM tensor core includes multiple processing units (PUs) organized in a 2D mesh network. Each PU is equipped with a first circuit 330 designed for low-precision (LP) computation. Additionally, a subset of PUs located in the central region 325 of the 2D mesh network is further equipped with a second circuit 340 configured to perform high-precision (HP) computation. Specifically, each PU in this central region 325 (represented in grey in FIG. 3) contains both the first circuit 330 for LP computation and the second circuit 340 for HP computation, while the remaining PUs in the 2D mesh network (shown in white in FIG. 3) include only the first circuit 330 for LP computation. This configuration allows all PUs to perform LP computation, with the PUs in the central region 325 also capable of executing HP computation.

In this context, LP computation involves distributed processing based on the LP representation of a sparse input tensor, such as the LP bits in the sparse representation of an activation tensor. HP computation, on the other hand, involves distributed processing based on the high-precision portion of the sparse input tensor, such as a condensed tensor containing only the high-magnitude (e.g., non-zero) tensor data from the sparse input tensor, represented by HP bits. The HP bits retain the high-magnitude tensor values, while the LP bits, with a reduced bit depth (e.g., 2 or 3 bits), carry positional information of the high-magnitude tensor data. The LP bits and HP bits may be stored together as the bitmask (tensor mask), or separately as independent data blocks. Both the tensor values and positional information are necessary for accurate tensor computation.

In some embodiments, the first circuit 330 for LP computation includes at least one activation register (denoted as I Register in FIG. 3), at least one weight register (denoted as W Register in FIG. 3), an LP vector multiplier, an LP vector adder, a scalar adder, and an accumulation register (denoted as Acc Register in FIG. 3). For example, the LP bits of a sparse activation tensor and a dense weight tensor are evenly distributed across the 2D mesh network of PUs for LP computation. The activation register in each PU is configured to store the assigned LP bits of the bitmask, while the weight register caches the weight corresponding to these LP bits (in some embodiments, the LP bits correspond to all tensor data in the sparse activation tensor, so the weight register caches all the weights for the LP bits, whereas the HP bits may correspond to only the high-magnitude data in the activation tensor, so the weight register may only cache the corresponding weights gathered from the LP bits). Both the LP bits (potentially encompassing multiple channels and thus forming a vector) and the corresponding weights are input to the LP vector multiplier, which corresponds to the multiplier array 170 in FIG. 1. The result of this multiplication then feeds into the vector adder (an adder tree structure that corresponds to the adder tree 180 in FIG. 1) to generate a partial sum. The scalar adder in the first circuit 330 is configured to add the partial sum with a previously cached partial sum in the accumulation register.

While all the PUs in the 2D mesh network are equipped with the first circuit 330, the PUs in the central region 325 further include the second circuit 340 for HP computation. In some embodiments, the second circuit 340 includes at least one activation register (denoted as I Register in FIG. 3), at least one weight register (denoted as W Register in FIG. 3), an HP vector multiplier, and an HP vector adder. For example, a condensed tensor extracted from (e.g., using a gather network) the sparse activation tensor may be evenly distributed across the subset of PUs in the central region 325 into the corresponding activation registers. The weights corresponding to the high-magnitude tensor data in the condensed tensor may be gathered (using the gather network) from the dense weight tensor and then distributed across the subset of PUs in the central region 325 into the corresponding weight registers. Similar to the LP computation, the HP bits in the activation register and the corresponding weights are input into the HP vector multiplier for vector multiplication. The multiplication result is fed into the vector adders (the HP adder tree) for channel reduction, thereby obtaining a partial sum. The partial sum may be stored in the accumulation register (of the first circuit 330 in the same PU) for accumulation with a previously cached partial sum.

In some embodiments, the 2D mesh network shown in FIG. 3 includes a specialized component called the center adder circuit 355. Located at the center of the 2D mesh network, the center adder circuit 355 connects to the quartet of (four) innermost PUs within the network. This circuit is designed to scale (optionally) and accumulate both the LP computation results from the first circuits across the 2D mesh network and the HP computation results from the second circuits in the central region 325 of the network.

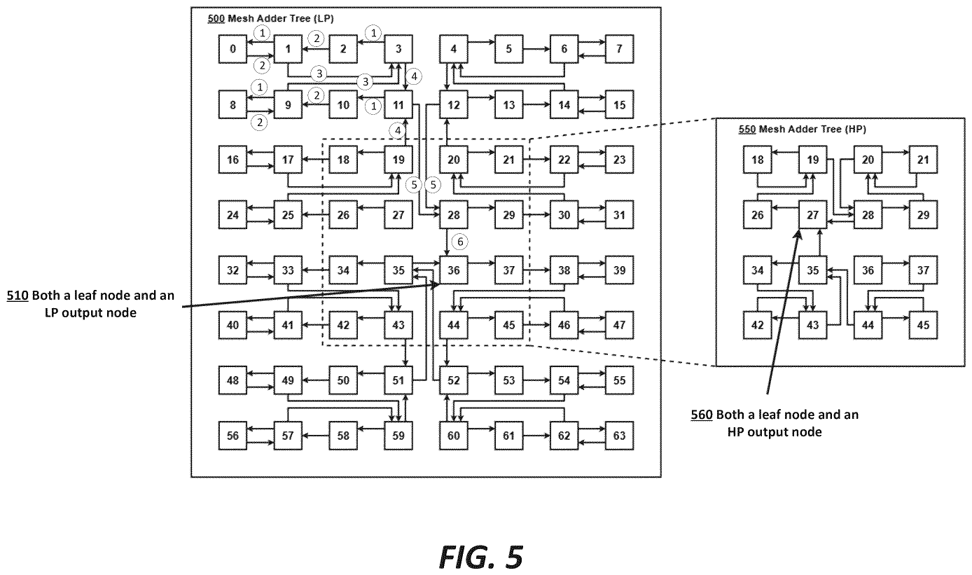

The center adder circuit 355's connection to the four innermost PUs is intentional, as both LP and HP computation results flow from all PUs toward these central PUs. During each execution cycle, one of the four innermost PUs generates the final LP computation results, while a non-adjacent innermost PU (e.g., on the diagonal) generates the final the HP computation results. The center adder circuit 355 then collects these computation results from the two non-adjacent PUs. This process is further detailed in FIG. 5, which illustrates the adder tree functionality of the CIM tensor core.

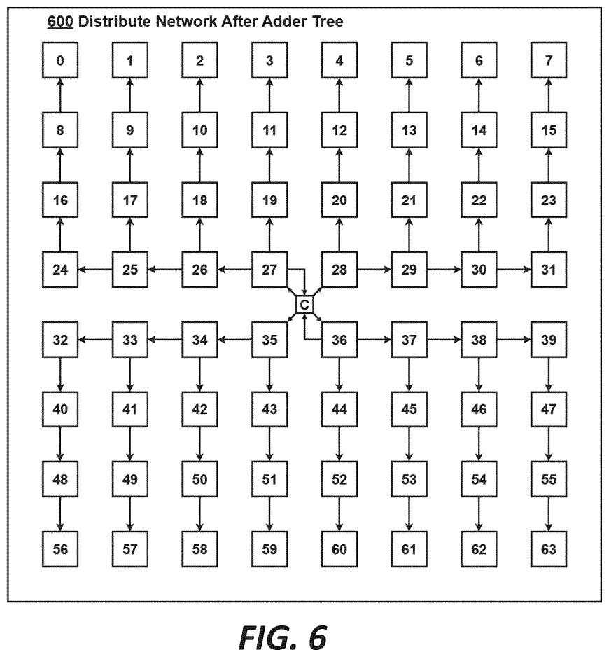

Notably, the center adder circuit 355 has bi-directional connections with two non-adjacent innermost PUs of the quartet of innermost PUs and uni-directional connections with the other two of the quartet of innermost PUs. This configuration allows the center adder circuit 355 to receive LP and HP computation results from the first two non-adjacent innermost PUs and distribute the accumulated results back to the PUs in the 2D mesh network through them, necessitating bi-directional connections. For the remaining two non-adjacent innermost PUs, the center adder circuit 355 only needs to distribute accumulated results to the PUs in the 2D mesh network, so uni-directional connections are sufficient. This process is further detailed in FIG. 6, which illustrates the distribute functionality of the CIM tensor core.

In some embodiments, the center adder circuit 355 includes an HP scaling register to store an HP scaling parameter, an LP scaling register to store an LP scaling parameter, an HP vector multiplier coupled to the HP scaling register, an LP vector multiplier coupled to the LP scaling register, and a vector adder connected to both the HP and LP vector multipliers.

The center adder circuit 355 effectively implements the functions of the scaling multiplier 184 and the scale parameter cache 186, of the pipeline-based tensor core shown in FIG. 1. In this configuration, the center adder circuit 355 is designed to receive the results of both the HP and LP computations. The HP vector multiplier within the center adder circuit 355 receives the HP computation results from the second circuits located in the central region of the 2D mesh network and applies the HP scaling parameter, stored in the HP scaling register, to generate a scaled HP result. This scaled HP result is then transmitted to the vector adder for accumulation.

Similarly, the LP vector multiplier receives the LP computation results from the first circuits distributed throughout the 2D mesh network and applies the LP scaling parameter, stored in the LP scaling register, to produce a scaled LP result. This scaled LP result is also transmitted to the vector adder, where it is accumulated with the scaled HP result.

It is noted that the vector adders in the center adder circuit 355 and the scalar adder in the first circuit are each designed to handle distinct types of tensor computations: intra-PU tensor computation and cross-PU computation, respectively. Consequently, only one of these adders is active at any given time.

In summary, the 2D mesh network of PUs illustrated in FIG. 3 can be conceptualized as a two-layer tensor core, with the bottom layer comprising first circuits configured for LP computations and the top layer, limited to the central region, comprising second circuits configured for HP computations. For sparse tensor computation in neural networks, at least one of the input tensors 310 (either the activation tensor or the weight tensor) may be sparse and represented by a condensed tensor (the HP layer) and LP bits (the LP layer). The sparse input tensor(s) are distributed across this two-layer tensor core, with the HP layer assigned to the second circuits in the top layer (central region 325) of the 2D mesh network, and the LP layer assigned to the first circuits in the bottom layer of the 2D mesh network, enabling efficient parallel computation.

As described above, the 2D mesh network of PUs in the CIM tensor core can be configured to perform various functions analogous to the various stages in the pipeline-based tensor core shown in FIG. 1. For instance, the control circuit 224 in FIG. 2 may send instructions to configure the 2D mesh network of PUs to function as a gather network, scatter network, LP adder tree, HP adder tree, distribute network, scaling parameter cache, scaling multiplier, accumulation cache and adder, and others as needed.

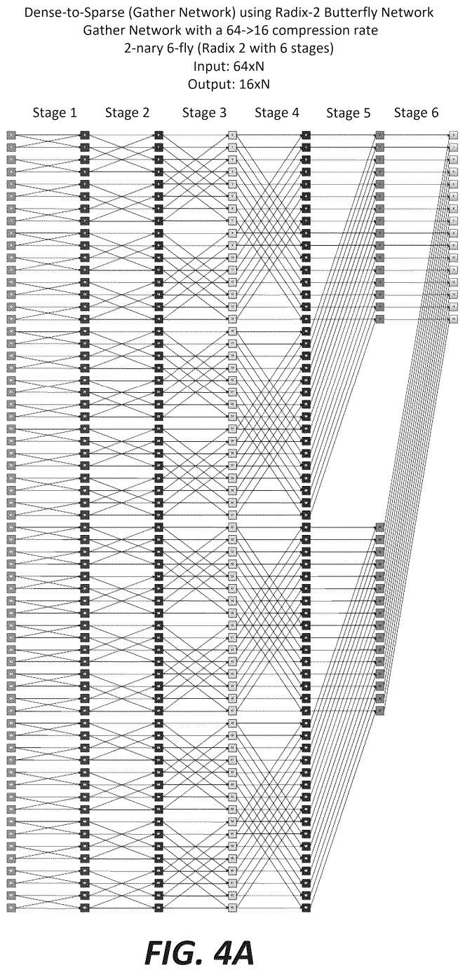

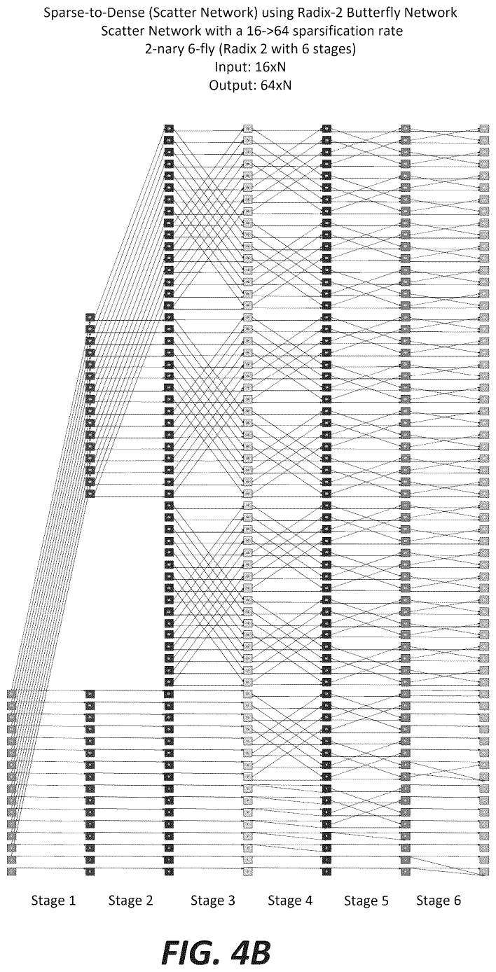

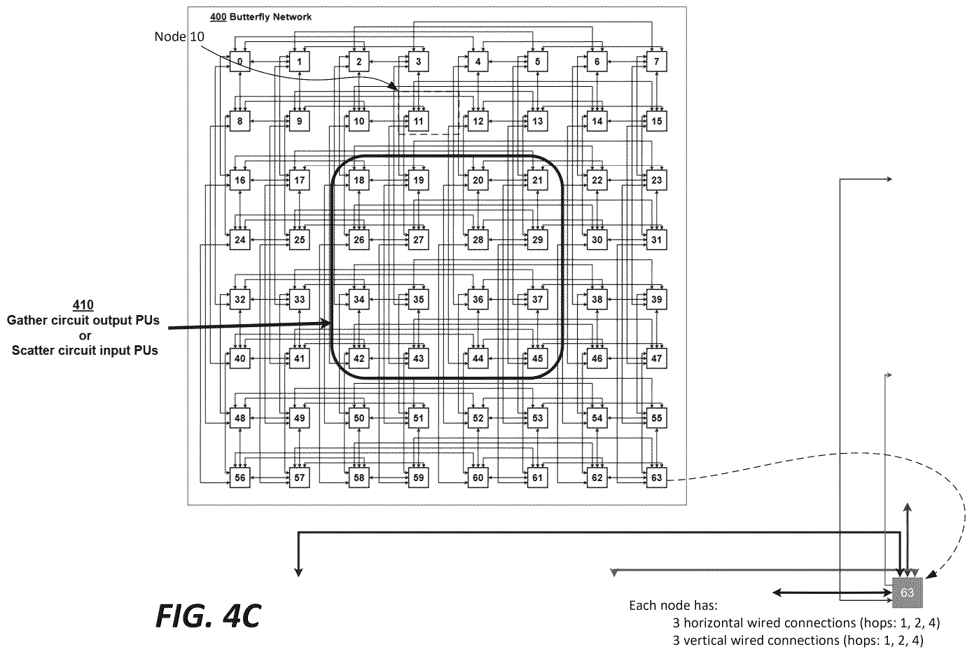

FIGS. 4A-4C illustrate an example configuration of the two-dimensional (2D) mesh network of PUs in the CIM tensor as a gather circuit or a scatter network by wiring the PUs as a 2D flattened butterfly network architecture.

FIG. 4A illustrates an original butterfly network configured as a gather circuit for sparse encoding. The gather circuit is designed to gather high-magnitude tensor data from a given tensor, and write into a condensed tensor as an output. The gathering of the high-magnitude tensor data may be based on a bitmask. The bitmask indicates the positions of the high-magnitude or non-zero elements in the tensor. The bitmask may be received from another engine or computed using a sorting circuit. For instance, the sorting circuit sorts the elements, and a processor is configured to identify the elements greater than a value threshold.

The gather circuit in FIG. 4A is implemented using the vanilla version of a butterfly network. Since the number of output values of the gather circuit is smaller than the number of input values, only part of the last layer of the butterfly network will be used as the output nodes.

For instance, FIG. 4A illustrates the gather circuit using the 2-nary 6-fly butterfly network. The gather circuit is designed to achieve 4× compression rate, e.g., compressing a given tensor with 64 elements into a condensed tensor with 16 elements. In this network, all the 64 nodes in the first layer are used as the input nodes, and only 16 nodes of the last layer are used the output nodes.

FIG. 4B illustrates an original butterfly network configured as a scatter circuit for sparse encoding. The scatter circuit is designed to scatter high-magnitude tensor data (HP data) from a given condensed tensor, and write into a sparse uncondensed tensor as an output. The scattering of the high-magnitude tensor data may be based on a HP bitmask (e.g., the HP portion in the bitmask).

The scatter circuit in FIG. 4B is implemented using the vanilla version of the butterfly network. Since the number of input values of the scatter circuit is smaller than the number of output values, only part of the first layer of the butterfly network will be used as the input nodes.

For instance, FIG. 4B illustrates the scatter circuit using the 2-nary 6-fly butterfly network. The scatter circuit is designed to achieve 4× sparsification rate, e.g., scattering a given tensor with 16 high-magnitude elements into a sparse uncondensed tensor with 64elements. Among the 64 elements in the sparse uncondensed tensor, only 16 elements are from the input condensed tensor, the remaining elements may be filled with zero-valued elements. In this network, only 16 nodes of the first layer are used the input nodes, and all the 64 nodes in the last layer are used as the output nodes.

Both the gather circuit in FIG. 4A and the scatter circuit in FIG. 4B utilize overlapping but distinct portions of the butterfly network. In practice, the gather circuit and the scatter circuit may be implemented on the same hardware to minimize costs. A straightforward (and naïve) approach is to use the full vanilla version of the butterfly network to implement both the gather circuit and the scatter circuit, with an instruction decoder or switch dynamically configuring the butterfly network to function as either the gather circuit or the scatter circuit, depending on the specific use case.

However, hardwiring the entire butterfly network involves a large number of nodes and complex, costly wiring. Since the goal of the this invention is to use the PUs in the same 2D mesh network for both gather and scatter, a 2D flattened butterfly architecture is described below in FIG. 4C.

FIG. 4C illustrates an exemplary configuration of the CIM tensor core as 2D flattened butterfly network 400 to function as a gather circuit or a scatter circuit, in accordance with various embodiments. As shown, the 2D flattened butterfly network 400 in FIG. 4C is implemented as a circuit-switched network, where a dedicated communication path is established between two nodes (PUs) for the duration of their connection. In this context, each node can represent either a router or a switch.

The 2D flattened butterfly network 400 in FIG. 4C simplifies the multi-stage butterfly network (as shown in FIGS. 4A and 4B) by “flattening” its stages into a single one. In the original multi-stage butterfly network, multiple routers are arranged in rows across different stages. The 2D flattened butterfly network 400 combines all routers in the same row across these stages into a single router.

Another improvement in the 2D flattened butterfly network 400 is that its wired connections are bidirectional, unlike the unidirectional connections used in the original butterfly network. This bidirectional nature enhances communication flexibility between nodes or PUs.

Each PU in the 2D flattened butterfly network 400 is equipped with 6 ports, which are used to implement the 6 non-horizontal wired connections corresponding to the 6 stages of the original butterfly network. This allows the network to maintain the same connectivity as the original multi-stage design while reducing complexity.

For illustrative purposes, the last node in the 2D flattened butterfly network 400 is taken out as an example to show the 6 wired connections. Among the 6 wired connections, 3 of them are horizontal connections in the 2D flattened butterfly network 400, and the other 3 of them are vertical connections in the 2D flattened butterfly network 400. Note that the horizontal connections in the 2D flattened butterfly network 400 are not the logical “horizontal connections” in each row of the butterfly network 300. The lengths (number of hops) of the horizontal connections and the vertical connections are in the pattern of 2⁰, 2¹, 2².

The input and output configurations of the 2D flattened butterfly network 400 differ depending on whether it is set up as a gather network or a scatter network.

When configured as a gather network, all PUs in the 2D flattened butterfly network 400 act as input nodes to receive tensor data from a dense tensor, such as a sparse activation or weight tensor, while the PUs in the central region 410 are reused as output nodes. In other words, the PUs in the central region 410 function as both input and output nodes. The output from these central PUs consists of the condensed tensor, containing only the high-magnitude tensor data gathered from the input dense tensor. In some embodiments, the output from the central region 410 may include gathered weights corresponding to a given set of HP activation data, supporting subsequent tensor computation. When the PUs in the central region 410 are subsequently configured as an HP adder tree, the output of the gather network may pass through the HP adder tree for accumulation, generating a partial sum.

Conversely, when the 2D flattened butterfly network 400 is configured as a scatter network, the PUs in the central region 410 are set as input nodes to receive a condensed tensor, and all PUs (including those in the central region 410) are configured as output nodes to output the uncondensed sparse tensor. The scatter network is activated when the output needs to be in a dense format.

FIG. 5 illustrates an exemplary configuration of the CIM tensor core as a multi-layer mesh adder tree designed to perform both low-precision (LP) and high-precision (HP) tensor computations, in accordance with various embodiments. As shown, the LP circuits of all PUs in the 2D mesh network of the CIM tensor core form an LP mesh adder tree 500, while the HP circuits of the PUs in the central region of the 2D mesh network constitute an HP mesh adder tree 550. Conceptually, the 2D mesh network has its bottom layer configured as the LP mesh adder tree 500, and its top layer configured as the HP mesh adder tree 550.

Each of the node in the LP mesh adder tree 500 and the HP mesh adder tree 550 includes both a multiplier circuit and an adder circuit (e.g., the multipliers and adders in 330 and 340 in FIG. 3) for performing local multiplication and accumulation.

In the LP mesh adder tree 500, nodes are connected in a specific configuration that forms a tree structure in a logical view, hence referred to as an “adder tree.” The root node of this tree is one of the quartet of innermost PUs in the central region, while all other nodes function as either leaf nodes or intermediate nodes. Each node in the LP mesh adder tree 500 is configured for local computation.

For example, first-level nodes receive activation values and weights for multiplication, generating a local intermediate result. They then accumulate this result with another intermediate result received from adjacent nodes, creating a new intermediate result that is forwarded to the next level. Second-level nodes receive intermediate results from multiple nodes, accumulate them to produce a new intermediate result, and pass this result to the subsequent level. The root node performs similar operations to the second-level nodes but does not need to send its output to any other node within the LP mesh adder tree 500. In some embodiments, the output from the LP mesh adder tree's root node is accumulated with the output from the root node of the HP mesh adder tree 550.

The HP mesh adder tree 550 is configured similarly to the LP mesh adder tree 500, though it comprises fewer nodes than the LP mesh adder tree 500 and uses different circuits for HP computation.

Using the example illustrated in FIG. 5, which depicts an 8×2 D mesh network with 64 nodes (labeled as nodes 0 through 63), data flow within the LP mesh adder tree from leaf nodes to the root node proceeds as follows:
Step 1: Node 1 sends its local computation result to node 0, and node 3 sends its result to node 2.
Step 2: Node 0 performs a local computation and sends its output to node 1; node 2 performs a local computation and sends its output to node 1.
Step 3: Node 1 receives data from nodes 0 and 2, performs an accumulation, and sends the result to node 3.
Step 4: Node 3 receives data from nodes 1 and 9 (another intermediate node similar to node 1), performs an accumulation, and sends the result to node 11.
Step 5: Node 11 receives data from nodes 3 and 19, performs an accumulation, and sends the result to node 28.
Step 6: Node 28 receives data from nodes 11 and 12, performs an accumulation, and sends the final result to node 36, which serves as the root node for caching the partial sum of the current LP execution cycle.

With this 2D mesh network of 64 nodes, reducing 64 inputs to a final output requires 6 steps (since 2⁶=64).

The HP mesh adder tree 550 functions in a similar manner, with node 27 serving as its root node.

In FIG. 5, within the LP mesh adder tree 500, node 36 serves as both a leaf node and the root or LP output node 510. Similarly, in the HP mesh adder tree 550, node 27 serves as both a leaf node and the root or HP output node 560.

FIG. 6 illustrates an exemplary configuration of the CIM tensor core as a distribute network, in accordance with various embodiments.

In some embodiments, the intermediate results from the HP output node 560 and the LP output node 510 (in FIG. 5) are fed into a central adder circuit (e.g., center adder circuit 355 in FIG. 3) for scaling and accumulation, producing the partial sum of the current execution cycle. This partial sum, which may take the form of a tensor or vector, may need to be redistributed back to the PUs for the next computation cycle. For instance, the partial sum from the current cycle can be cached and used in accumulation with local results in the following execution round. The CIM tensor core can be configured as a distribute network 600 to effectively handle the distribution (or broadcasting) of the partial sum from the central adder circuit to the PUs in 2D mesh network.

As illustrated in FIG. 6, the distribution of data from the center adder circuit (denoted as “c” at the center of the distribute network 600) begins with the quartet of innermost PUs.

Note that the connections between the center adder circuit and two non-adjacent PUs in this quartet—specifically, node 27 and node 36 (the root or output nodes of the HP and LP mesh adder trees, respectively)—are bidirectional. In contrast, the connections between the center adder circuit and the other two non-adjacent innermost PUs are unidirectional. This configuration is intentional: the center adder circuit both receives outputs from the root nodes 27 and 36 and distributes the partial sums back to them, necessitating bidirectional connections. For the other two innermost PUs, the center adder circuit only needs to distribute the partial sums, so unidirectional connections are sufficient.

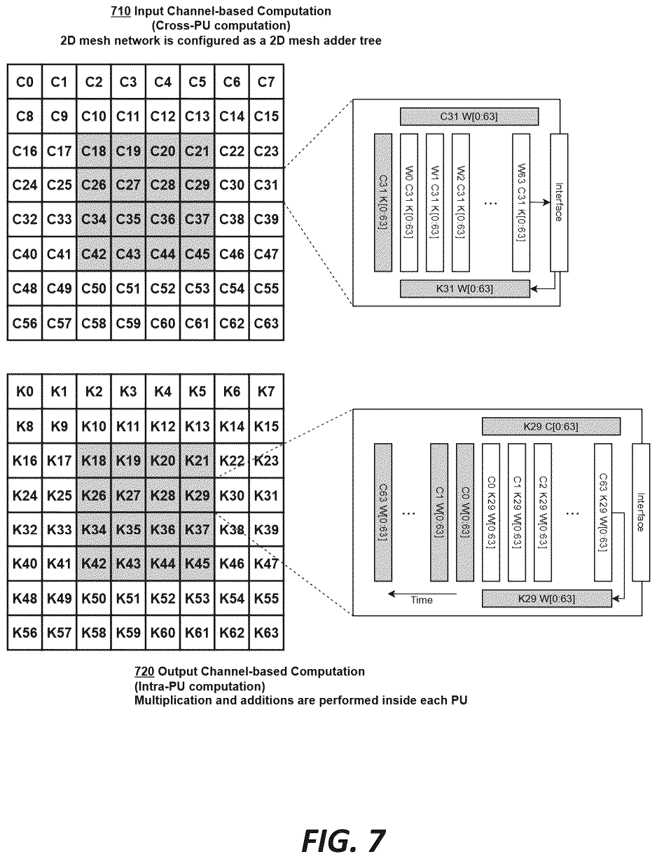

FIG. 7 illustrates two computation modes supported by the CIM tensor core, in accordance with various embodiments. Different applications or use cases may feed input tensors into the 2D mesh network in different ways, leading to different computation modes. For instance, the input tensor may be distributed based on its input channels or output channels. Accordingly, the CIM tensor core needs to support both input channel-based computation 710 and output channel-based computation 720 using the same PUs in the 2D mesh network.

A person skilled in the art will appreciate that input channel-based computation 710 requires cross-PU computation—that is, the PUs need to migrate their local results for accumulation with other PUs. This process can be implemented by configuring the PUs as the 2D mesh adder tree(s) illustrated in FIG. 6.

In contrast, output channel-based computation 720 requires intra-PU computation, meaning the multiplications and accumulations are performed locally within each PU, eliminating the need for cross-PU data migration. In this case, the local multipliers and adder trees inside the PUs are activated to handle the computation.

For this reason, referring to FIG. 3, the vector adder in the center adder circuit 355 is activated for input channel-based computation 710, while the scalar adder in the first circuit for LP computation 330 is activated for output channel-based computation 720. The center adder circuit 355 and the scalar adder are not activated simultaneously.

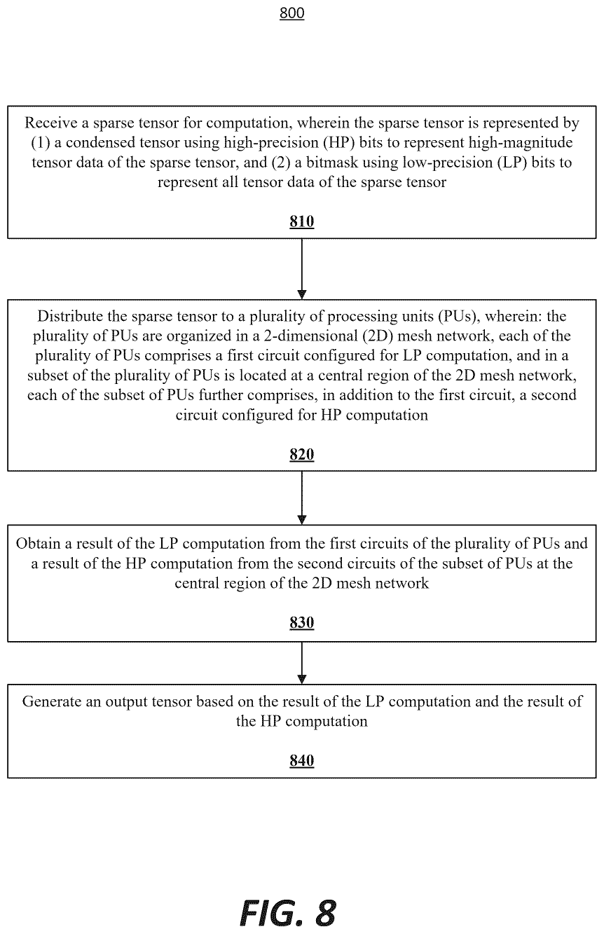

FIG. 8 illustrate an example process 800 performed by the CIM tensor core, in accordance with various embodiments. In some implementations, one or more process blocks of FIG. 8 may be performed by a device.

As shown in FIG. 8, process 800 may include receiving a sparse tensor for computation, where the sparse tensor is represented by (1) a condensed tensor using high-precision (HP) bits to represent high-magnitude tensor data of the sparse tensor, and (2) low-precision (LP) bits representing all tensor data of the sparse tensor (block 810). For example, the device may receive a sparse tensor for computation, where the sparse tensor is represented by (1) a condensed tensor using HP bits to represent high-magnitude tensor data of the sparse tensor, and (2) LP bits to represent all tensor data of the sparse tensor, as described above.

As also shown in FIG. 8, process 800 may include distributing the sparse tensor to a plurality of processing units (PUs), where: the plurality of PUs are organized in a 2-dimensional (2D) mesh network, each of the plurality of PUs may include a first circuit configured for LP computation, and in a subset of the plurality of PUs is located at a central region of the 2D mesh network, each of the subset of PUs further may include, in addition to the first circuit, a second circuit configured for HP computation (block 820). For example, the device may distribute the sparse tensor to a plurality of processing units (pus), where: the plurality of pus are organized in a 2-dimensional (2d) mesh network, each of the plurality of pus may include a first circuit configured for LP computation, and in a subset of the plurality of PUs is located at a central region of the 2d mesh network, each of the subset of pus further may include, in addition to the first circuit, a second circuit configured for HP computation, as described above.

As further shown in FIG. 8, process 800 may include obtaining a result of the LP computation from the first circuits of the plurality of PUs and a result of the HP computation from the second circuits of the subset of PUs at the central region of the 2D mesh network (block 830). For example, the device may obtain a result of the LP computation from the first circuits of the plurality of PUs and a result of the HP computation from the second circuits of the subset of PUs at the central region of the 2d mesh network, as described above.

As also shown in FIG. 8, process 800 may include generating an output tensor based on the result of the LP computation and the result of the HP computation (block 840). For example, the device may generate an output tensor based on the result of the LP computation and the result of the hp computation, as described above.

Process 800 may include additional implementations, such as any single implementation or any combination of implementations described below and/or in connection with one or more other processes described elsewhere herein. In a first implementation, the distributing the sparse tensor to the plurality of PUs may include: distributing the condensed tensor to the second circuits of the subset of PUs in the central region of the 2D mesh network for the HP computation; and distributing the LP bits to the first circuits of the plurality of PUs in the 2D mesh network for LP computation.

In a second implementation, alone or in combination with the first implementation, the 2D mesh network further may include: a center adder circuit located in the center of the 2D mesh network, connected to the quartet of innermost PUs in the 2D mesh network, where: the center adder circuit may include: an HP scaling register that stores an HP scaling parameter; an LP scaling register that stores an LP scaling parameter; an HP vector multiplier coupled to the HP scaling register; an LP vector multiplier coupled to the LP scaling register; and a vector adder coupled to the HP vector multiplier and the LP vector multiplier.

In a third implementation, alone or in combination with the first and second implementation, the generating the output tensor based on the result of the LP computation and the result of the HP computation may include: feeding the result of the LP computation and the result of the HP computation to the center adder circuit; generating, using the LP vector multiplier, a scaled result of the LP computation by applying the LP scaling parameter from the LP scaling register; generating, using the HP vector multiplier, a scaled result of the HP computation by applying the HP scaling parameter from the HP scaling register; and accumulating, using the vector adder, the scaled result of the LP computation and the scaled result of the HP computation to obtain the output tensor.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional circuits and sold or used as independent products, they can be stored in a processor executable non-volatile computer-readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training samples to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A tensor core, comprising:
a memory;
a control circuit; and
a plurality of processing units (PUs) organized in a 2-dimensional (2D) mesh network,
wherein:
each of the plurality of PUs comprising a first circuit configured for low-precision (LP) computation, and
in a subset of the plurality of PUs located within a central region of the 2D mesh network, each of the subset of PUs further comprises, in addition to the first circuit, a second circuit configured for high-precision (HP) computation.

2. The tensor core of claim 1, wherein the first circuit is configured to support compute-in-memory computation, and
the first circuit comprises at least one activation register, at least one weight register, an LP vector multiplier, an LP vector adder, a scalar adder, and an accumulation register.

3. The tensor core of claim 1, wherein the second circuit is configured to support compute-in-memory computation, and
the second circuit comprises at least one activation register, at least one weight register, an HP vector multiplier, and an HP vector adder.

4. The tensor core of claim 1, wherein:
the plurality of PUs are configured to receive a sparse tensor for computation, wherein the sparse tensor is represented by:
a condensed tensor using HP bits to represent high-magnitude tensor data of the sparse tensor, and
LP bits representing all tensor data of the sparse tensor.

5. The tensor core of claim 4, wherein the control circuit is configured to send control instructions to:
distribute the condensed tensor to the second circuits of the subset of PUs in the central region of the 2D mesh network for HP computation; and
distribute the LP bits to the first circuits of the plurality of PUs in the 2D mesh network for LP computation.

6. The tensor core of claim 1, wherein the control circuit configures the plurality of PUs as a gather circuit, in which:
the plurality of PUs are configured to receive tensor data, and the subset of the PUs in the center region of the 2D mesh network are configured to gather and output high-magnitude tensor data in the received data.

7. The tensor core of claim 1, wherein the control circuit configures the plurality of PUs as a scatter circuit, in which:
the subset of the PUs in the center region of the 2D mesh network are configured to receive high-magnitude tensor data, and the plurality of PUs are configured to scatter the high-magnitude tensor data to a dense tensor and output the dense tensor.

8. The tensor core of claim 1, further comprising:
a center adder circuit located in the center of the 2D mesh network, connected to a quartet of innermost PUs in the 2D mesh network, wherein:
the center adder circuit comprises:
an HP scaling register that stores an HP scaling parameter;
an LP scaling register that stores an LP scaling parameter;
an HP vector multiplier coupled to the HP scaling register;
an LP vector multiplier coupled to the LP scaling register; and
a vector adder coupled to the HP vector multiplier and the LP vector multiplier.

9. The tensor core of claim 8, wherein the HP vector multiplier is configured to:
receive a result of the HP computation from the second circuits of the subset of PUs in the central region of the 2D mesh network;
generate a scaled result of the HP computation by applying the HP scaling parameter from the HP scaling register; and
transmit the scaled result of the HP computation to the vector adder for accumulation with a scaled result of the LP computation.

10. The tensor core of claim 8, wherein the LP vector multiplier is configured to:
receive a result of the LP computation from the first circuits of the plurality of PUs in the 2D mesh network;
generate a scaled result of the LP computation by applying the LP scaling parameter from the LP scaling register; and
transmit the scaled result of the LP computation to the vector adder for accumulation with a scaled result of the HP computation.

11. The tensor core of claim 8, wherein the center adder circuit comprises:
bi-directional connections with two non-adjacent PUs of the quartet of innermost PUs in the 2D mesh network, and
uni-directional connections with the other two non-adjacent PUs of the quartet of innermost PUs in the 2D mesh network.

12. The tensor core of claim 1, wherein the control circuit configures the first circuits of the plurality of PUs as an LP mesh adder tree, LP tensor data are accumulated through the LP mesh adder tree and flow towards a root node of the LP mesh adder tree, and the root node corresponds to one of the quartet of innermost PUs.

13. The tensor core of claim 1, wherein the control circuit configures the second circuits of the subset of PUs in the central region of the 2D mesh network as an HP mesh adder tree, HP tensor data are accumulated through the HP mesh adder tree and flow towards a root node of the HP mesh adder tree, and the root node corresponds to one of the quartet of innermost PUs.

14. The tensor core of claim 8, wherein the center adder circuit is configured to:
generate a vector result based on a result of the HP computation and a result of the LP computation; and
redistribute the vector result back to the plurality of PUs for accumulation in a next round of computation.

15. The tensor core of claim 1, wherein the plurality of PUs is configurable to perform either intra-PU accumulation or cross-PU accumulation.

16. The tensor core of claim 15, wherein the control circuit configures the plurality of PUs to perform either intra-PU accumulation or cross-PU accumulation, depending on whether an input tensor for computation is distributed by input channel or by output channel.

17. A method, comprising:
receiving a sparse tensor for computation, wherein the sparse tensor is represented by (1) a condensed tensor using high-precision (HP) bits to represent high-magnitude tensor data of the sparse tensor, and (2) low-precision (LP) bits representing all tensor data of the sparse tensor;
distributing the sparse tensor to a plurality of processing units (PUs), wherein:
the plurality of PUs are organized in a 2-dimensional (2D) mesh network,
each of the plurality of PUs comprises a first circuit configured for LP computation, and
in a subset of the plurality of PUs is located at a central region of the 2D mesh network, each of the subset of PUs further comprises, in addition to the first circuit, a second circuit configured for HP computation;
obtaining a result of the LP computation from the first circuits of the plurality of PUs and a result of the HP computation from the second circuits of the subset of PUs at the central region of the 2D mesh network; and
generating an output tensor based on the result of the LP computation and the result of the HP computation.

18. The method of claim 17, wherein the distributing the sparse tensor to the plurality of PUs comprises:
distributing the condensed tensor to the second circuits of the subset of PUs in the central region of the 2D mesh network for the HP computation; and
distributing the LP bits to the first circuits of the plurality of PUs in the 2D mesh network for LP computation.

19. The method of claim 17, wherein the 2D mesh network further comprises:
a center adder circuit located in the center of the 2D mesh network, connected to the quartet of innermost PUs in the 2D mesh network, wherein:
the center adder circuit comprises:
an HP scaling register that stores an HP scaling parameter;
an LP scaling register that stores an LP scaling parameter;
an HP vector multiplier coupled to the HP scaling register;
an LP vector multiplier coupled to the LP scaling register; and
a vector adder coupled to the HP vector multiplier and the LP vector multiplier.

20. The method of claim 19, wherein the generating the output tensor based on the result of the LP computation and the result of the HP computation comprises:
feeding the result of the LP computation and the result of the HP computation to the center adder circuit;
generating, using the LP vector multiplier, a scaled result of the LP computation by applying the LP scaling parameter from the LP scaling register;
generating, using the HP vector multiplier, a scaled result of the HP computation by applying the HP scaling parameter from the HP scaling register; and
accumulating, using the vector adder, the scaled result of the LP computation and the scaled result of the HP computation to obtain the output tensor.
